(19) United States
(12) Patent Application Publication
(10) Pub. No.: US 2023/0173482 A1
(43) Pub. Date: Jun. 8, 2023

(54) URINE ANALYSIS SYSTEMS AND METHODS

(71) Applicant: Beckman Coulter, Inc., Brea, CA (US)

(72) Inventors: Karan Patel, Brea, CA (US); Gaurav Vyas, Brea, CA (US); Vinay Prathapan, Brea, CA (US)

(21) Appl. No.: 18/074,609

(22) Filed: Dec. 5, 2022

Related U.S. Application Data
(60) Provisional application No. 63/286,082, filed on Dec. 5, 2021.

(51) Int. Cl. B01L 3/00

(52) U.S. Cl. CPC B01L 3/5023; B01L 2200/04; B01L 2200/025; B01L 2300/0654; B01L 2300/069; B01L 2300/0825

(57) ABSTRACT

A system for measuring a biological sample includes a sample collection vessel and a removable analysis cartridge that is removable from the sample collection vessel.

### CROSS-REFERENCE TO RELATED APPLICATION

This application claims the benefit of priority to U.S. Provisional Patent Application Ser. No. 63/286,082 filed Dec. 5, 2021, the disclosure of which is incorporated herein in its entirety by reference.

### FIELD OF THE INVENTION

The present invention relates to the field of wholly or partially automated systems, analyzers and methods for the collection and analysis of particles contained in fluid samples, such as urine samples, including analysis by imaging.

### BACKGROUND

Urine analysis, or urinalysis, is one of the most routinely ordered diagnostic tests and is used to detect a wide range of conditions such as urinary tract infections, diabetes, liver diseases or kidney diseases. Urinalysis may be tested for a variety of reasons including as part of a routine medical exam, cancer therapy monitoring, pregnancy check-up, hospital admission, drug testing, drug screening, or pre-surgical work-up. Urinalysis includes physical, chemical, and microscopic tests; a complete urinalysis consists of all three distinct testing phases. A visual test is conducted to evaluate urine color and clarity. A chemical test can be used to measure a number of substances to provide health or disease information and, in a manual embodiment, may be performed by a clinical technician dipping a reagent test strip, which may also be referred to as a chemical test strip or dipstick, into the urine and making an evaluation based on the change in color of the test strip.

Urine samples may be evaluated by a chemistry test and/or microscopy test. Urine samples are collected from the patient in sealable sample cups which may be poured into sample test tubes.

For a chemistry test, a test strip may be dipped into the urine by a clinical technician and, once removed, the technician will manually compare the strip to a color chart provided by the manufacturer. It is for this reason that it is important that the technician has followed the prescribed sample absorption time closely, or the result reliability may be compromised depending on the degree of excess or shortage of reaction time. It is apparent to one in the art how cumbersome and error-prone this operation can be.

A microscopic test can identify types and number of cells, casts, crystals or other components such as bacteria or mucus. Like chemical urinalysis, the process of manual microscopic urinalysis can be messy and tedious. Microscopic urinalysis requires the urine sample to be centrifuged to separate the sample by density. Denser substances are concentrated at the bottom of the tube and the liquid at the top of the tube is discarded. The drops of concentrated fluid at the bottom are then transferred onto a slide and examined by microscope where observable objects can be measured by visual count. Such objects include red blood cells (RBCs), white blood cells (WBCs), epithelial cells, bacteria, yeast, sperm, mucus, parasites, casts, broad casts, and crystals, such as crystals of calcium oxalate, uric acid, triple phosphate, amino acids, drugs, renal epithelial cells, squamous epithelial cells, oval fat bodies, or other particles or contaminates such as fibers or skin cells.

The results of visual measurements are known to vary by hospital lab and by individual lab technician. Even with a standard unit of measurement, such as cells per high-powered field, the number of cells that a technician will see varies depending on the method used to make the visual inspection. Variations in measurements arise from the time that the sample has been stored prior to inspection and also in the length and speed of the centrifugation step. Further in the process, a certain microscope may have a field of view that differs from others and the number of high-power fields that a technician observes may also vary depending on the backlog or number of samples waiting to be processed. Sampling bias may also have an impact, as a variation in measurement may result from different aliquots taken from the same tube.

If a urinalysis test result appears to be abnormal, repeat testing is typically ordered automatically due to the known variability of results. The repeat testing may be performed on the same patient sample or a new patient sample.

Sample degradation due to the method and duration of transport or storage prior to analysis is another factor which may affect the viability of the test result. The longer the time that passes between collection and analysis the less viable the results. If longer than one hour transpires between collection and analysis, the sample must be refrigerated, and a preservative may be added.

Unlike blood tests, where the sample is drawn by a skilled professional, urine samples may be collected by the patient providing the sample or by clinicians, such as by a catheter, and the quality and amount of sample can vary greatly depending, for example, on the patient's dexterity and level of hydration. Pouring the sample from the collection cup to the sample tube can expose the sample to contaminants, such as dust or other particulate matter, affecting the sample integrity. This pouring can also result in splashes or spills, which can be a hazard to the lab technician and could leave too little sample for testing, e.g., if the volume of sample remaining after a spill will not cover the testing portions of a chemistry test strip.

Newer, automated solutions have helped to speed the process while improving standardization and accuracy in urinalysis labs by removing the differences between laboratory microscopes or technician techniques. There are also automated urinalysis systems which can pipette samples onto chemistry test strip and report the results. Based on which results are positive, automated systems can also make a decision to send the sample to an additional step to measure particles instead of a manual slide review. Automated particle analysis may be conducted by flow cytometry, in place of microscopy, to analyze urine sediment or sediment analysis. Flow cytometry is a system which characterizes particles by detecting fluorescence and/or light scatter produced by a stream of cells passing one at a time through a laser beam. Digital imaging is yet another automated alternative to manual microscopy, with the added benefit that images can be saved to a patient record and reviewed again at a later time if needed. In traditional microscopy, once a slide was reviewed it would typically be discarded, so that it was not possible to review the sample again once the results were reported. Furthermore, these systems are able to reduce observer-related variability of results and provide a more rapid, reliable, accurate and overall more reproducible system. Automated solutions also automatically record and report the results, further saving time and reducing the risk of reporting errors. These are some of the reasons why automated solutions are often favored. However, automated systems are often more expensive and do not meet the needs of all labs. Available automated systems are not ideal for smaller laboratories, point-of-care centers or clinics with limited budgets where the service and maintenance-related costs of these systems may hinder the labs' ability to operate effectively as these costs may not be ideally matched to the less frequent use of these systems in these settings.

Additionally, some of the benefits of an automated solution may not be fully obtained, such as instances where a user needs to visually inspect the sample to confirm certain flagged results. Furthermore, these automated solutions still do not address several components of the manual process that are cumbersome, including pouring or other transfer method of the sample from the collection cup into a test tube or other vessel compatible with certain automated systems. Additionally, centrifugation required for certain automated urine sediment analyzers may result in particle loss. Considerable technician training may be needed to use these systems, especially those with digital image review systems significantly differing from traditional manual microscopy.

Flow imaging is another automated solution which may be used for sediment analysis, instead of microscopy. Flow imaging is a method for analyzing particles suspended in a fluid by passing them through a flow cell in which a particle analyzer may capture images of each individual particle. Thus, these systems might be more accurate than microscope imaging systems which rely on counting in-focus particles within a selected field of view. However, carryover is an issue in present urinalysis systems, particularly in automated solutions, such as flow cytometry. Carryover is a metric which describes the percentage of left-over sample particles which affect subsequent samples. Because many of the components in automated systems, such as the fluidics of a flow-cytometry machine, are not single-use, left-over particles may affect the results of subsequent tests.

There remains a need for a simplified urine analysis system to improve workflow simplicity and accuracy of analysis. There also remains a need for a urine analysis system which can provide automated solutions that can be scaled to be used at the point of care, in smaller hospital labs, or larger labs.

### SUMMARY

In various aspects, this disclosure relates to a system for measuring a biological sample. The system includes a sample collection vessel. The system also include a removable analysis cartridge that is removable from the sample collection vessel.

In various aspects, this disclosure relates to a sample collection vessel that includes one or more holes that allow a biological sample to flow from a sample holding potion of the sample collection vessel onto and/or into a removable analysis cartridge. The sample collection vessel includes a slot underneath the holes to house the removable analysis cartridge. The sample collection vessel includes a flow locking mechanism to allow and prevent flow of the biological sample to the removable analysis cartridge. The sample collection vessel also includes an analysis cartridge locking mechanism that locks the removable analysis cartridge in place after insertion into the sample collection vessel and that releases the removable analysis cartridge for removal from the sample collection vessel.

In various aspects, this disclosure relates to an analysis cartridge. The analysis cartridge includes a flat strip that includes one or more micro-wells including a chemical reagent and/or preservative, one or more sample-absorbent pads treated with a chemical reagent, or a combination thereof. The analysis cartridge can include an optical collection well for presentation of a biological sample for optical analysis.

In some aspects, this disclosure relates to a low carryover urinalysis system. The system may be used in diagnostic labs, at the point of care, or in physician office labs, for example. This system may be efficient for use in low-throughput labs as it may take up as little space as possible. This system may include a single-use specimen collection cup with an integrated, removable cartridge. The cartridge may be integrated at the bottom of the sample cup. The sample collection vessel may include a locking mechanism to either allow or prevent flow of specimen to the cartridge. In some aspects, this locking mechanism may be reversible.

In some aspects, the cartridge may include sample-absorbent pads or chemical reagents which can be measured by the system to provide a result. The pads or reagents may be contained in micro-wells on the cartridge. The cartridge may incorporate a microfluidic design to properly dose the pads or chemical reagents. The cartridge may also include an optical collection well to collect and concentrate a sample without spillage or external contamination, to present the sample for optical examination. In some aspects, a cartridge may include microfluidic features to collect the most relevant sample particles and concentrate them into a sample well. In some aspects, the analysis cartridge may contain preservatives to inhibit sample degradation. In some aspects, this cartridge may be adapted for fluorescence imaging by incorporating fluorescent markers, stains, or dyes. In some aspects, this cartridge may not be adapted for fluorescence imaging. In some aspects, the sample cartridge, once removed from the collection cup, may be placed onto a staging module of an analyzer.

In some aspects, this analyzer may involve an imaging module which may acquire images of the sample. These images may then undergo an automated particle recognition process to identify and label the detected particles. In some aspects, the imaging module may scan the cartridge well in three directions, along the defined x, y, and z axes. The sample results may then be interpolated from the acquired images. In some aspects, artificial intelligence or machine learning may be used to measure the results. In some aspects the image data may be compiled into a Z-stacked, 3D representation of the scanned sample volume.

In some aspects, this analyzer may involve a urine chemistry module. This chemistry module may activate chemicals contained in the sample cartridge to allow the analyzer to interpret chemistry results. The chemistry module may have an imaging process, which may scan a chemistry component of the cartridge to determine pad color change or sample color change due to its chemical reaction with a reagent. In some aspects, this imaging process may occur at a defined incubation time.

In some aspects, the analyzer may be amenable to functional or throughput expansion. This may be accomplished by integrating multiple imaging modules or additional test modalities. This may also be accomplished by adding a staging module with a cartridge transport system or automated batch handling system.

### BRIEF DESCRIPTION OF THE DRAWINGS

FIG. 1 is an exemplary flow chart in accordance with aspects of this disclosure.

FIG. 2 is a model of an exemplary specimen collection cup with cartridge and slider lock in accordance with aspects of this disclosure.

FIG. 3 is a cross-sectional model illustrating the exemplary slider lock in collection position in accordance with aspects of this disclosure.

FIG. 4 is a cross-sectional model illustrating the slider lock in lock position in accordance with aspects of this disclosure.

FIG. 5 is a cross-sectional model illustrating the exemplary cartridge being removed after the slider lock has been engaged in lock position in accordance with aspects of this disclosure.

FIG. 6 is an exemplary urine analysis system in accordance with aspects of this disclosure.

FIG. 7 is a side view of an exemplary urine analysis system in accordance with aspects of this disclosure.

FIG. 8 is a photograph of a removable analysis cartridge in accordance with aspects of this disclosure.

### DETAILED DESCRIPTION

Prior efforts to provide an automated or semi-automated, objective urinalysis test have not yet fully addressed many of the workflow liabilities of traditional urinalysis, especially sample transfer. Many automated solutions continue to require a technician to pour sample from a collection cup into an additional tube and/or centrifuge the sample. Additionally, prior efforts have not fully addressed test variability issues and may cause sample carryover. Carryover is a metric which describes left-over sample particles which affect subsequent samples. Many automated solutions that include both urine chemistry and sediment analysis, in place of microscopy, utilize flow imaging or flow cytometry. Because many of the components in such automated systems are not single-use, unlike traditional methods, left-over particles may become trapped in the fluidics of the system and affect the results of subsequent tests. Furthermore, conventional automated urinalysis systems may not be suitable to all medical laboratories due to their cost and size inefficiencies for mid to small laboratories or point of care circumstances. There remains a need for a simplified, one-piece flow, urine analysis system to both improve workflow simplicity and accuracy of analysis.

Urine samples can degrade due to the method and duration of transport or storage prior to analysis. The longer the time that passes between collection and analysis the less viable the results. If longer than one hour transpires between collection and analysis, the sample must be refrigerated, and a preservative may be added. A quick, straightforward sample preparation process may help reduce variability in urinalysis results by reducing the time between sample collection and testing. For example, a point of care testing device could reduce the amount of time that passes between collection and analysis.

The urinalysis system disclosed herein seeks to address some of the aforementioned issues by providing a low carryover, small foot-print analyzer which utilizes a single-use sample collection cup with an integrated cartridge with sample-absorbent pads or chemical reagents on cartridge in addition to an integrated sample-concentrating cartridge which may be read by the analyzer to produce usable sediment analysis results.

The present invention can be a low carryover, automated urinalysis system. Certain embodiments of this system may resolve one or more of the workflow or accuracy challenges associated with previous solutions. Benefits of certain embodiments of this system may include a small size or suitability to low-throughput labs. Certain embodiments could allow for one-piece flow to improve workflow simplicity and accuracy of analysis. One-piece flow means that the sample would not have to be manually transferred into additional tubes, slides, or other measurement containers.

In some aspects, this disclosure relates to a low carryover urinalysis system. Low carryover refers to the aspect that the system may not allow significant left-over particles to remain in the system after testing an individual biological sample which may be obtained from a patient. Low carryover may be low, very low, or zero carryover. Particles may include cells, or casts or any other object which may be introduced into the system via a first sample and could be erroneously attributed to a second sample if not removed from the system between testing the first and second samples. Patient may refer to any human or animal from whom a fluid sample may be obtained for analysis including inpatients, those admitted to a medical facility for longer than one day, outpatients, those admitted to a medical facility for less than one day, remote patients, those seen outside of a medical facility, or research subjects, for example. A biological sample may include any fluid sample such urine, blood, amniotic fluid, aqueous humor, bile, cerebrospinal fluid, lymph, mucus, pericardial fluid, peritoneal fluid, pleural fluid, saliva, semen, sputum, synovial fluid, tears, vaginal secretions, resuspended cells, or any other biological fluid. Features that a diagnostic system might measure in these samples include features measured by a particle analyzer or features that might be measured by a chemistry analyzer. These features may also be referred to as substances, biological substances, objects, particles, sediments, or components. Features that may be measured by a particle analyzer may include red blood cells (RBCs), white blood cells (WBCs), epithelial cells, bacteria, yeast, sperm, mucus, parasites, casts, pathological casts, small round cells, WBC clumps, broad, bacteria, and crystals, such as calcium oxalate, uric acid, triple phosphate, amino acids, drugs, renal epithelial cells, squamous epithelial cells, nonsquamous epithelial cells, hyaline casts, unclassified casts, amorphous substances, oval fat bodies, or other particles or contaminates such as fibers or skin cells. These features may be measured by collecting images by an imaging system or automated microscopy with digital imaging, then analyzing these images to identify and enumerate the given particle using image analysis techniques or particle recognition techniques. Other features that may be measured through image analysis techniques include a change in color or fluorescence due to the interaction of the sample with chemical reagents. These features may alternatively or additionally be measured using flow cytometry. Turbidity may also be measured using the image analysis system.

Features that may be measured by a chemistry analyzer include a change in color or fluorescence due to the interaction of the sample with chemical reagents. These features may be measured using an imaging system and using automated image analysis techniques to measure specific color properties or by utilizing reflectance photometry. These chemical tests may include pH, hemoglobin, specific gravity or osmolality, protein, glucose, ketones, nitrite, blood, bilirubin, urobilinogen, ascorbic acid, or leukocyte esterase. The system may be used in diagnostic labs, at the point of care, or in a physician office lab (POL), for example. Point of care, also referred to as near-patient testing, may be a diagnostic test performed not in a separate lab, but as close to the patient as possible. This may be at the point of sample collection, or patient triage or entry into a healthcare facility, in an emergency vehicle, retail clinics, general practitioner's offices, urgent care clinics, hospitals, or in remote settings away from a hospital care facility such as combat zones or in areas lacking hospital centers. A diagnostic lab may refer to any facility that consists of the means of testing patient samples for health information such as hospital labs, university labs or veterinary clinics. A POL may refer to a diagnostic lab in a physician practice setting for or examining specimens as part of a primary care physician's practice. This system may be low-throughput and with a small footprint, thus satisfying the needs of these use-cases.

The system can be a system for measuring a biological sample, such as a urine sample. The system can include a sample collection vessel and a removable analysis cartridge that is removable from the sample collection vessel. The sample collection vessel may have one removable analysis cartridge or multiple removable analysis cartridges. The removable analysis cartridge may have multiple compartments for conducting repeat testing on the sample. The removable analysis cartridge can be slidably removable from the sample collection vessel when inserted therein.

The sample collection vessel may be a single-use, disposable collection vessel. The removable analysis cartridge may be integrated at the bottom of the sample vessel. The sample vessel may be any container capable of holding a fluid sample and may include cups, tubes, or any other shape. The sample vessel may be a single-use, disposable unit.

The biological sample can be collected directly into the sample collection vessel, such as into a sample cup or sample holding portion of the sample collection vessel. The sample cup or sample holding portion of the sample collection vessel can be free of reagents and/or dyes, or can contain one or more dry reagents and/or dyes. The sample collection vessel can include one or more holes in the sample cup (e.g., sample holding portion) of the sample collection vessel that allow at least a portion of the biological sample to flow onto and/or into the removable analysis cartridge. In various aspects, each hole in the sample cup aligns with a pad or well on the removable analysis cartridge.

The sample collection vessel can include a slot underneath the holes, wherein the slot is fluidly connected to the holes, the slot being for housing the removable analysis cartridge while it is inserted into the sample collection vessel. The removable analysis cartridge can be in the form of a flat strip, wherein the slot orients the removable analysis cartridge such that major faces of the removable analysis cartridge are perpendicular to the one or more holes. The slot can include an open end for insertion or removal of the removable analysis cartridge. The slot can include a closed end to abut against an end of the removable analysis cartridge during insertion thereof, or to abut against a resilient member (e.g., spring) that abuts against the end of the removable analysis cartridge during insertion thereof. In various aspects, the slot can include one or more seals that prevent leakage of liquids from the slot when the removable analysis cartridge is inserted therein.

The sample collection vessel and/or analysis cartridge may include a locking mechanism to either allow or prevent flow of specimen to the cartridge, and/or to allow or prevent removal of the analysis cartridge. The locking mechanism may include holes which allow specimen to flow into the cartridge when in the open position. When the locking mechanism is in the closed position the analysis cartridge may be removed from the cup for analysis without specimen leakage. The locking mechanism may be a gating mechanism. The locking mechanism and cartridge may be a sliding mechanism. The locking mechanism and cartridge may be a rotational, twist-to-lock mechanism. The locking mechanism may be a switch system, in which the locking mechanism may be slid in one direction to lock the system and in another direction to allow specimen to flow into the cartridge. The locking mechanism may be reversible, or irreversible.

The sample collection vessel can include a flow locking mechanism to allow or prevent flow of the biological sample from the sample cup (e.g., sample holding portion) of the sample collection vessel to the removable analysis cartridge. The flow locking mechanism can include a mechanism that moves one or more holes in a bottom of the sample cup into or out of alignment with another set of holes in a layer or plate that is below that bottom of the sample cup. For example, the flow locking mechanism can include a sample holding portion bottom layer and a flow lock layer each including one or more holes, wherein the one or lore holes of the sample holding portion bottom layer and the flow locking layer move into alignment during unlocking of the flow locking mechanism, and wherein the one or more holes of the sample holding portion bottom layer and the flow locking layer move out of alignment during locking of the flow locking mechanism, wherein the aligned holes are in fluid communication with one another, and wherein the unaligned holes prevent fluid flow therebetween. The flow locking mechanism can be reversible, or irreversible. The flow locking mechanism can include one or more seals to prevent leakage of liquid from the flow locking mechanism.

The flow locking mechanism can be opened or closed by a rotational mechanism, such as a rotational mechanism including a central axis that aligns with a central axis (e.g., vertical axis) of the sample collection vessel. For example, the rotational mechanism can include a portion of the exterior of the sample collection vessel that is rotated by the user, such as a tab or an external sliding layer of the vessel. The flow locking mechanism can be opened or closed by a bidirectional sliding mechanism, such as a tab or an external sliding layer of the vessel.

The sample collection vessel can include an analysis cartridge locking mechanism that locks the removable analysis cartridge in place after insertion into the sample collection vessel and that releases the removable analysis cartridge for removal from the sample collection vessel. In various aspects, the analysis cartridge locking mechanism can be opened or closed using the same user action or actions as used to open or close a flow locking mechanism; in other aspects, the analysis cartridge locking mechanism is opened or closed using different user action or actions than used to open or close the flow locking mechanism, such that the analysis cartridge locking mechanism and the flow locking mechanism can be independently operated by the user. The analysis cartridge locking mechanism can be reversible, or irreversible.

The analysis cartridge locking mechanism can be opened or closed by a rotational mechanism that includes a central axis that aligns with a central axis of the sample collection vessel (e.g., a vertical axis). For example, the rotational mechanism can include a portion of the exterior of the sample collection vessel that is rotated by the user, such as a tab or an external sliding layer of the vessel. The analysis cartridge locking mechanism can be opened or closed by a bidirectional sliding mechanisms, such as a tab or an external sliding layer of the vessel.

The analysis cartridge locking mechanism can include one or more extendible pins that extend between the removable analysis cartridge and the sample collection vessel and hold the removable analysis cartridge in plane in the sample collection vessel (e.g., in a slot in the sample collection vessel) for housing the removable analysis cartridge therein). The one or more extendible pins can extend from the sample collection vessel into holes or slots in the removable analysis cartridge.

The analysis cartridge locking mechanism can include a door that covers an opening of a slot for housing the removable analysis cartridge during locking of the analysis cartridge locking mechanism, and that exposes the opening of the slot during unlocking of the analysis cartridge locking mechanism. The door can include or can part of a slidable layer on or in the sample collection vessel, such as a slidable jacket or a slidable inner layer reachable by a tab that extends through an opening in one or more outer layers of the sample collection vessel.

The analysis cartridge locking mechanism can include a portion underneath a slot for housing the removable analysis cartridge in the sample collection vessel that applies pressure against the removable analysis cartridge during locking of the analysis cartridge locking mechanism, and that releases the pressure during unlocking of the analysis cartridge locking mechanism.

The analysis cartridge locking mechanism can include a resilient member in a slot for housing the removable analysis cartridge in the sample collection vessel. The resilient member can be any suitable resilient member, such as a spring or piece of elastomeric material. The resilient member can push the removable analysis cartridge at least partially out of the slot during unlocking of the analysis cartridge locking mechanism.

In various aspects, the sample collection vessel can include a non-reinsertion mechanism that prevents the removable analysis cartridge from being re-inserted into the sample collection vessel after the biological sample has been placed in and/or on the removable analysis cartridge by the sample collection vessel.

The removable analysis cartridge can further include a microfluidic system. The microfluidic system can deliver sample volumes of the biological sample to at least one micro-well and/or sample pad on the removable analysis cartridge. The micro-well can include a chemical reagent, a preservative, or a combination thereof. The sample pad can be a sample-absorbent pad. At least one of the sample-absorbent pads can be pre-treated with a chemical reagent. The removable analysis cartridge can include an optical collection well for presentation of the biological sample for optical analysis, such as for microscopy analysis or other optical analysis. In various aspects, the system further includes an optical system for optical analysis of the biological sample, such as for optical analysis of the biological sample in the optical collection well of the removable analysis cartridge.

In some aspects, the analysis cartridge may include sample-absorbent chemical pads or chemical reagents not integrated into pads which, after reacting with the patient sample, may be analyzed by the system to provide a result. The pads or reagents may be contained in micro-wells on the analysis cartridge. The analysis cartridge may incorporate a microfluidic design to accurately dose the pads or chemical reagents with the biological sample. The cartridge may be able to collect and concentrate the collected sample without spillage or external contamination. In some aspects, this cartridge may include microfluidic features to collect the most relevant sample particles and concentrate them into a sample well. In some aspects, this cartridge may be adapted for fluorescence imaging by incorporating fluorescent stains or dyes. In some aspects, the sample cartridge, once removed from the collection cup, may be placed onto a staging module of an analyzer. The cartridge may alternately be referred to as an optical collection well, as the cartridge can be imaged.

In some aspects, the analysis cartridge may contain preservatives to inhibit sample degradation. These preservatives may be applied as a coating to the analysis cartridge. For example, preservatives may include boric acid, hydrochloric acid, acetic acid, oxalic acid, sodium propionate.

The system can further include an analyzer for measuring features of the biological sample. In various aspects, the system is free of an analyzer, while in other embodiments, the system includes an analyzer. The analyzer can include measure any one or more features of the biological sample, such as by analyzing the sample in the removable analysis cartridge. The system can include an imaging module, a chemistry analysis module, a method for determining a result, a method for displaying the result, or a combination thereof. The chemistry analysis module can analyze for a change in the reagents contained in the removable analysis cartridge caused by interaction with the biological sample. In various aspects, the result can be a 2D or 3D representation of the scanned sample volume. The analyzer can further include a processor configured with instructions stored on a non-transitory computer readable medium to, when executed, cause the processor to perform acts including obtaining one or more measurements of the biological sample, and interpolating a result form the one or more measurements, such as one or more image measurements.

In some aspects, the analyzer may involve an imaging module which may scan and record images of the sample in the cartridge (e.g., in an optical collection well in the cartridge). These images may then undergo an automated particle recognition process to identify and label the detected particles. In some aspects, the imaging module may scan the cartridge well in three directions, along the defined x, y, and z axis. The sample results may then be interpolated from the acquired images. In some aspects, artificial intelligence or machine learning may be used to measure the results. Machine learning or artificial intelligence may include the use of algorithms or statistical models to improve test accuracy with limited human interaction based on input data. In some aspects the image data may be compiled into a Z-stacked, 3D representation of the scanned sample volume.

In some aspects, this analyzer may involve a urine chemistry module. This chemistry module may allow for the activation of chemical reagents contained in the sample cartridge so that the analyzer may interpret urine chemistry results. The chemistry module may have an imaging module which may scan a chemistry component of the cartridge to determine pad color change or sample color change in response to its chemical reaction with a reagent. Once the tests are completed, the sample results may be displayed. In some aspects, the sample results may include a notification that the results are abnormal.

In some aspects, the analyzer may be modularly expandable to satisfy functional or throughput expansion. This may be accomplished by integrating multiple modular components such as imaging modules, additional imaging modalities, a staging module with a cartridge transport system, or automated batch handling system.

In various aspects, the present disclosure provides a sample collection vessel, such as any suitable sample collection vessel disclosed herein for use in the system for analysis of a biological sample. The sample collection vessel can include one or more holes that allow a biological sample to flow from a sample holding portion of the sample collection vessel onto and/or into a removable analysis cartridge. The sample collection vessel can include a slot underneath the holes to house the removable analysis cartridge. The sample collection vessel can include a flow locking mechanism to allow and prevent flow of the biological sample to the removable analysis cartridge. The sample collection vessel can also include an analysis cartridge locking mechanism that locks the removable analysis cartridge in place after insertion into the sample collection vessel and that releases the removable analysis cartridge for removal from the sample collection vessel.

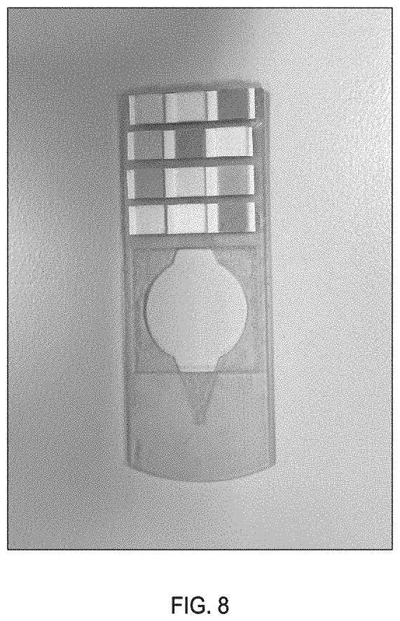

In various aspects, the present disclosure provides an analysis cartridge, such as any suitable removable analysis cartridge disclosed herein for use in the system for analysis of a biological sample. The analysis cartridge can include a flat strip. The analysis cartridge can be in the form of a flat strip. The flat strip can include one or more micro-wells including a chemical reagent and/or preservative, one or more sample-absorbent pads treated with a chemical reagent, or a combination thereof. The analysis cartridge can also include an optical collection well for presentation of a biological sample for optical analysis. FIG. 8 illustrates a photograph of removable analysis cartridge including nine sample-absorbent pads arranged in three rows of three pads, and including an optical collection well for presentation of a biological sample for optical analysis.

### EXAMPLES

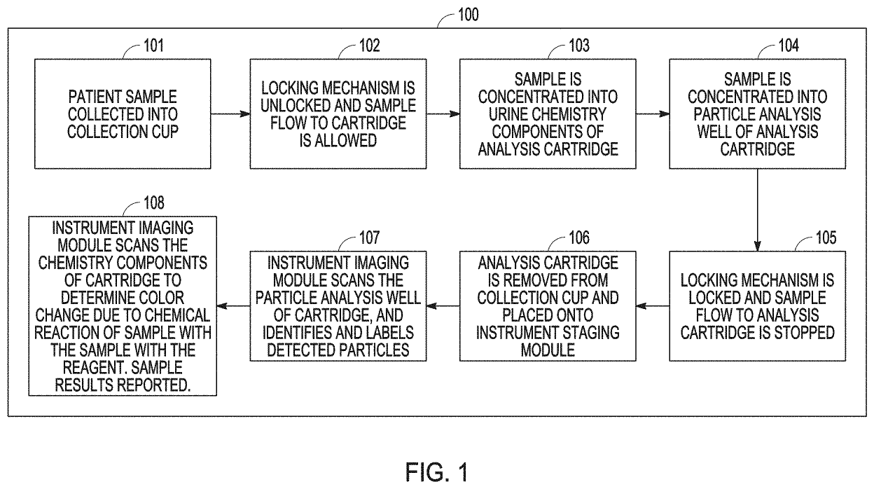

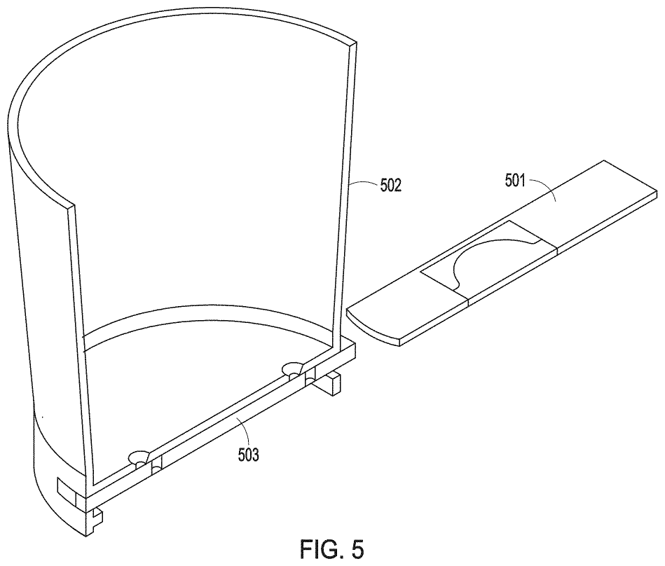

As shown in FIG. 1, an exemplary system 100 in accordance with the present disclosure is illustrated. A patient sample may be collected into a collection cup 101 and flow to a removable analysis cartridge may be allowed by unlocking a locking mechanism 102. This analysis cartridge may be an optical cartridge, meaning it is possible to use with an imaging system or microscopy system. The analysis cartridge may include a microfluidic system, microwells for containing chemical reagents, or an optical well for concentrating particles for analysis. The locking mechanism may be a sliding mechanism. The locking mechanism may be a twist-to-lock system. The locking mechanism may be a switch system, in which the locking mechanism may be slid in one direction to lock the system and in another direction to allow specimen to flow into the cartridge. The sample may then be concentrated onto urine chemistry components of the integrated analysis cartridge 103. The urine chemistry components may be sample-absorbent pads or chemical reagents contained in micro-wells. The sample may be concentrated in these components by a microfluidic system. The sample may also be concentrated into a particle analysis well of the analysis cartridge 104. The sample may be concentrated into the particle analysis well by a microfluidic system. A locking mechanism may then be engaged, further preventing flow of sample into the analysis cartridge 105. The analysis cartridge may then be removed from the collection cup and placed onto an analyzer staging module to begin analysis 106. The analysis cartridge may be slidably removed from the sample vessel, as depicted in FIG. 5. The analysis cartridge may also be removed by a twist to lock or unlock mechanism, wherein the locking mechanism may be twisted to misalign the holes for the sample flow and allow the cartridge to be removed. A switch system may also be used to open or close the holes for the sample flow by pushing the switch bidirectionally to align or misalign the holes and allow the cartridge to be removed. An optical system of the analyzer may scan the particle analysis well of the cartridge, record images, and identify and label detected particles 107. The optical system may involve digital imaging or automated microscopy wherein microscope views may be imaged. This imaging module may utilize flow imaging technology. All images may be stored for future review. An imaging module may scan the urine chemistry components of the analysis cartridge to determine color change due to a chemical reaction that has taken place between the sample and reagents and the complete sample results may be reported 108.

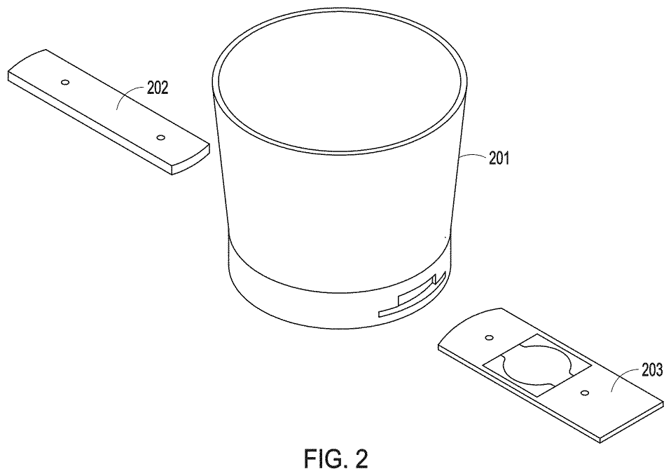

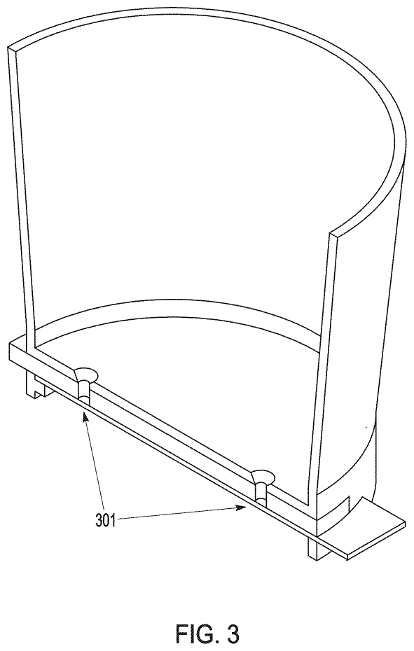

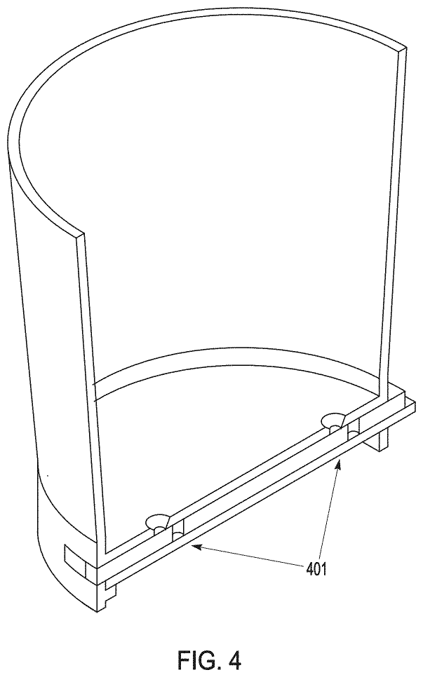

FIG. 2 depicts an exemplary sample collection cup with an exemplary locking mechanism 202 and removable analysis cartridge 203. In this exemplary system, both the locking mechanism and cartridge are sliding mechanisms. FIG. 3 is a cross-sectional view of this system wherein the locking mechanism 301 is unlocked, allowing the sample to flow through two holes, into the analysis cartridge. FIG. 4 is a cross-sectional view of the locking mechanism 401 slid to the lock position, wherein the holes of the locking mechanism are no longer aligned, thus preventing the sample from flowing into the analysis cartridge. FIG. 5 depicts the now-filled analysis cartridge 501 being slidably removed from the collection cup 502, with the locking mechanism 503 in lock position.

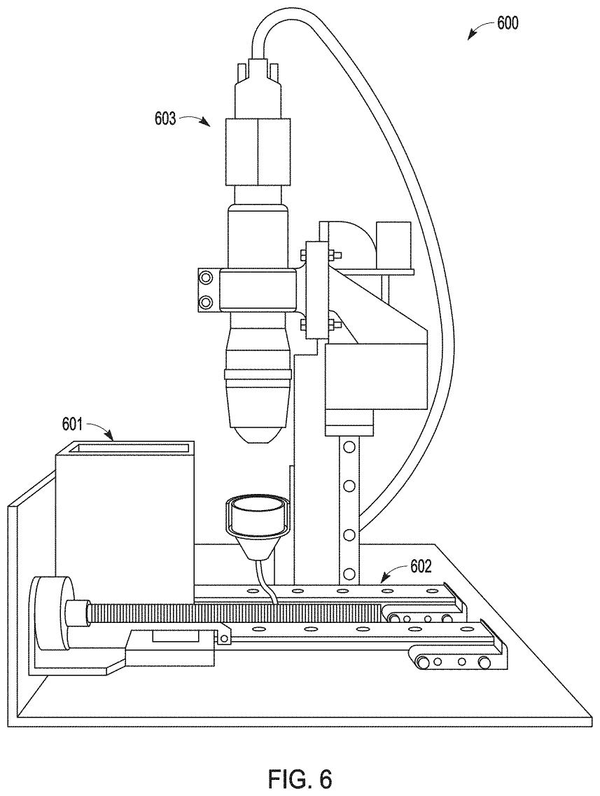

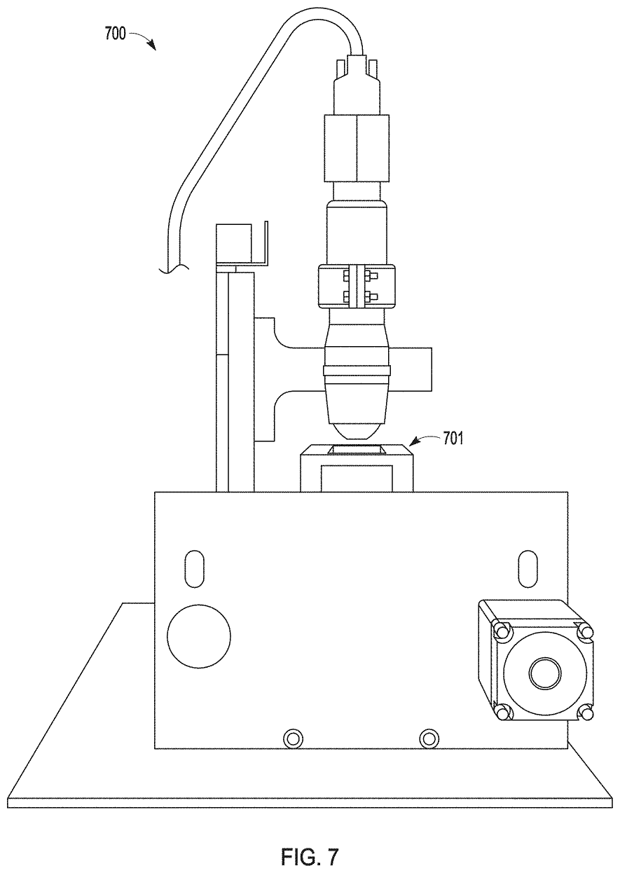

FIG. 6 shows the components of an exemplary analyzer system 600 with a cartridge stage 601 in which the analysis cartridge may be placed and a cartridge transport module 602 which may then position the cartridge beneath an imaging module 603. The cartridge module may be adjusted in the x, y, and z directions to take multiple images. FIG. 7 shows a side view of this analyzer system 700 and cartridge stage 701.

The dimensions and values disclosed herein are not to be understood as being strictly limited to the exact numerical values recited. Instead, unless otherwise specified, each such dimension is intended to mean both the recited value and a functionally equivalent range surrounding that value to include at least the variability due to the reproducibility of measurements made using the test methods described herein, or industry-standard test methods if no test method is expressly disclosed.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Exemplary Embodiments

The following exemplary embodiments are provided, the numbering of which is not to be construed as designating levels of importance:

Embodiment 1 provides a system for measuring a biological sample comprising:
a sample collection vessel; and
a removable analysis cartridge that is removable from the sample collection vessel.

Embodiment 2 provides the system of Embodiment 1, wherein the biological sample is collected directly into the sample collection vessel.

Embodiment 3 provides the system of any one of Embodiments 1-2, wherein the removable analysis cartridge is slidably removable from the sample collection vessel.

Embodiment 4 provides the system of any one of Embodiments 1-3, wherein the sample collection vessel comprises one or more holes that allow the biological sample to flow from a sample holding potion of the sample collection vessel onto and/or into the removable analysis cartridge, wherein the sample collection vessel comprises a slot underneath the holes and fluidly connected to the holes to house the removable analysis cartridge.

Embodiment 5 provides the system of Embodiment 4, wherein the removable analysis cartridge is in the form of a flat strip, wherein the slot orients the removable analysis cartridge such that major faces of the removable analysis cartridge are perpendicular to the one or more holes.

Embodiment 6 provides the system of any one of Embodiments 4-5, wherein the slot comprises an open end to insert or remove the removable analysis cartridge and a closed end to abut against an end of the removable analysis cartridge during insertion thereof.

Embodiment 7 provides the system of any one of Embodiments 1-6, wherein the sample collection vessel further comprises a flow locking mechanism to allow or prevent flow of the biological sample to the removable analysis cartridge.

Embodiment 8 provides the system of Embodiment 7, wherein the flow locking mechanism comprises a sample holding portion bottom layer and a flow locking layer each comprising one or more holes, wherein the one or more holes of the sample holding portion bottom layer and the flow locking layer move into alignment during unlocking of the flow locking mechanism, and wherein the one or more holes of the sample holding portion bottom layer and the flow locking layer move out of alignment during locking the of the flow locking mechanism.

Embodiment 9 provides the system of any one of Embodiments 7-8, wherein the flow locking mechanism is reversible.

Embodiment 10 provides the system of any one of Embodiments 7-9, wherein the flow locking mechanism is opened or closed by a rotational mechanism comprising a central axis that aligns with a central axis of the sample collection vessel.

Embodiment 11 provides the system of any one of Embodiments 7-10, wherein the flow locking mechanism is opened or closed by a bidirectional sliding mechanism.

Embodiment 12 provides the system of any one of Embodiments 1-11, wherein the sample collection vessel further comprises an analysis cartridge locking mechanism that locks the removable analysis cartridge in place after insertion into the sample collection vessel and that releases the removable analysis cartridge for removal from the sample collection vessel.

Embodiment 13 provides the system of Embodiment 12, wherein the analysis cartridge locking mechanism is reversible.

Embodiment 14 provides the system of any one of Embodiments 12-13, wherein the analysis cartridge locking mechanism is opened or closed by a rotational mechanism comprising a central axis that aligns with a central axis of the sample collection vessel.

Embodiment 15 provides the system of any one of Embodiments 12-14, wherein the analysis cartridge locking mechanism is opened or closed by a bidirectional sliding mechanism.

Embodiment 16 provides the system of any one of Embodiments 12-15, wherein the analysis cartridge locking mechanism comprises one or more extendible pins that extend between the removable analysis cartridge and the sample collection vessel and hold the removable analysis cartridge in place in the sample collection vessel.

Embodiment 17 provides the system of Embodiment 16, wherein the one or more extendible pins extend from the sample collection vessel into holes or slots in the removable analysis cartridge.

Embodiment 18 provides the system of any one of Embodiments 12-17, wherein the analysis cartridge locking mechanism comprises a door that covers an opening of a slot for housing the removable analysis cartridge during locking of the analysis cartridge locking mechanism, and that exposes the opening of the slot during unlocking of the analysis cartridge locking mechanism.

Embodiment 19 provides the system of Embodiment 18, wherein the door comprises a slidable layer on or in the sample collection vessel.

Embodiment 20 provides the system of any one of Embodiments 12-19, wherein the analysis cartridge locking mechanism comprises a portion underneath a slot for housing the removable analysis cartridge in the sample collection vessel that applies pressure against the removable analysis cartridge during locking of the analysis cartridge locking mechanism, and that releases the pressure during unlocking of the analysis cartridge locking mechanism.

Embodiment 21 provides the system of any one of Embodiments 12-20, wherein the analysis cartridge locking mechanism comprises a resilient member in a slot for housing the removable analysis cartridge in the sample collection vessel, wherein the resilient member pushes the removable analysis cartridge at least partially out of the slot luring unlocking of the analysis cartridge locking mechanism.

Embodiment 22 provides the system of any one of Embodiments 12-21, wherein the sample collection vessel comprises a non-reinsertion mechanism that prevents the removable analysis cartridge from being re-inserted into the sample collection vessel after the biological sample has been placed in and/or on the removable analysis cartridge by the sample collection vessel.

Embodiment 23 provides the system of any one of Embodiments 1-22, wherein the analysis cartridge further comprises a microfluidic system.

Embodiment 24 provides the system of Embodiment 23, wherein the microfluidic system delivers sample volumes of the biological sample to at least one micro-well and/or sample pad on the removable analysis cartridge.

Embodiment 25 provides the system of any one of Embodiments 1-24, wherein the removable analysis cartridge comprises one or more micro-wells, wherein at least one of the micro-wells contain a chemical reagent.

Embodiment 26 provides the system of any one of Embodiments 1-25, wherein the removable analysis cartridge comprises one or more micro-wells, wherein at least one of the micro-wells contain one or more preservatives.

Embodiment 27 provides the system of any one of Embodiments 1-26, wherein the removable analysis cartridge comprises one or more sample-absorbent pads, wherein at least one of the sample-absorbent pads is treated with a chemical reagent.

Embodiment 28 provides the system of any one of Embodiments 1-27, wherein the removable analysis cartridge comprises an optical collection well for presentation of the biological sample for optical analysis.

Embodiment 29 provides the system of any one of Embodiments 1-28, wherein the system further comprises an optical system.

Embodiment 30 provides the system of any one of Embodiments 1-29, wherein the system further comprises an analyzer for measuring features of the biological sample.

Embodiment 31 provides the system of Embodiment 30, wherein the analyzer further comprises an imaging module.

Embodiment 32 provides the system of any one of Embodiments 30-31, wherein the analyzer further comprises a chemistry analysis module.

Embodiment 33 provides the system of Embodiment 32, wherein the chemistry analysis module analyzes any change in the reagents contained in the analysis cartridge caused by interaction with biological sample.

Embodiment 34 provides the system of any one of Embodiments 30-33, wherein the analyzer further comprises a method for determining a result.

Embodiment 35 provides the system of Embodiment 34, wherein the analyzer further comprises a method for displaying the result.

Embodiment 36 provides the system of any one of Embodiments 34-35, wherein the result comprises a 3D representation of the scanned sample volume.

Embodiment 37 provides the system of any one of Embodiments 30-36, wherein the analyzer further comprises a processor configured with instructions stored on a non-transitory computer readable medium to, when executed, cause the processor to perform acts comprising:
obtaining one or more measurements of the biological sample; and
interpolating a result from the one or more measurements.

Embodiment 38 provides the system of Embodiment 37, wherein the one or more measurements comprise image measurements.

Embodiment 39 provides the system of any one of Embodiments 37-38, wherein the analyzer further comprises a method for displaying the result.

Embodiment 40 provides a sample collection vessel comprising:
one or more holes that allow a biological sample to flow via gravity from a sample holding potion of the sample collection vessel onto and/or into a removable analysis cartridge,
a slot underneath the holes to house the removable analysis cartridge,
a flow flocking mechanism to allow and prevent flow of the biological sample to the removable analysis cartridge,
an analysis cartridge locking mechanism that locks the removable analysis cartridge in place after insertion into the sample collection vessel and that releases the removable analysis cartridge for removal from the sample collection vessel.

Embodiment 41 provides an analysis cartridge comprising:
a flat strip comprising
   one or more micro-wells comprising a chemical reagent and/or preservative, one or more sample-absorbent pads treated with a chemical reagent, or a combination thereof; and
   an optical collection well for presentation of a biological sample for optical analysis.

Embodiment 42 provides the system, sample collection vessel, or analysis cartridge of any one or any combination of Embodiments 1-41 optionally configured such that all elements or options recited are available to use or select from.

What is claimed is:

1. A system for measuring a biological sample comprising:
a sample collection vessel; and
a removable analysis cartridge that is removable from the sample collection vessel.

2. The system of claim 1, wherein the sample collection vessel comprises one or more holes that allow the biological sample to flow from a sample holding potion of the sample collection vessel onto and/or into the removable analysis cartridge.

3. The system of claim 2, wherein the sample collection vessel comprises a slot underneath the holes and fluidly connected to the holes to house the removable analysis cartridge, wherein the removable analysis cartridge is in the form of a flat strip, wherein the slot orients the removable analysis cartridge such that major faces of the removable analysis cartridge are perpendicular to the one or more holes.

4. The system of claim 1, wherein the sample collection vessel further comprises a flow locking mechanism to allow or prevent flow of the biological sample to the removable analysis cartridge.

5. The system of claim 4, wherein the flow locking mechanism comprises a sample holding portion bottom layer and a flow locking layer each comprising one or more holes, wherein the one or more holes of the sample holding portion bottom layer and the flow locking layer move into alignment during unlocking of the flow locking mechanism, and wherein the one or more holes of the sample holding portion bottom layer and the flow locking layer move out of alignment during locking the of the flow locking mechanism.

6. The system of claim 4, wherein the flow locking mechanism is opened or closed by a rotational mechanism comprising a central axis that aligns with a central axis of the sample collection vessel.

7. The system of claim 1, wherein the sample collection vessel further comprises an analysis cartridge locking mechanism that locks the removable analysis cartridge in place after insertion into the sample collection vessel and that releases the removable analysis cartridge for removal from the sample collection vessel.

8. The system of claim 7, wherein the analysis cartridge locking mechanism is opened or closed by a rotational mechanism comprising a central axis that aligns with a central axis of the sample collection vessel.

9. The system of claim 7, wherein the analysis cartridge locking mechanism comprises one or more extendible pins that extend between the removable analysis cartridge and the sample collection vessel and hold the removable analysis cartridge in place in the sample collection vessel.

10. The system of claim 7, wherein the analysis cartridge locking mechanism comprises a door that covers an opening of a slot for housing the removable analysis cartridge during locking of the analysis cartridge locking mechanism, and that exposes the opening of the slot during unlocking of the analysis cartridge locking mechanism.

11. The system of claim 7, wherein the analysis cartridge locking mechanism comprises a portion underneath a slot for housing the removable analysis cartridge in the sample collection vessel that applies pressure against the removable analysis cartridge during locking of the analysis cartridge locking mechanism, and that releases the pressure during unlocking of the analysis cartridge locking mechanism.

12. The system of claim 7, wherein the analysis cartridge locking mechanism comprises a resilient member in a slot for housing the removable analysis cartridge in the sample collection vessel, wherein the resilient member pushes the removable analysis cartridge at least partially out of the slot during unlocking of the analysis cartridge locking mechanism.

13. The system of claim 7, wherein the sample collection vessel comprises a non-reinsertion mechanism that prevents the removable analysis cartridge from being re-inserted into the sample collection vessel after the biological sample has been placed in and/or on the removable analysis cartridge by the sample collection vessel.

14. The system of claim 1, wherein the analysis cartridge further comprises a microfluidic system that delivers sample volumes of the biological sample to at least one micro-well and/or sample pad on the removable analysis cartridge.

15. The system of claim 1, wherein
the removable analysis cartridge comprises one or more micro-wells, wherein at least one of the micro-wells contain one or more preservatives; and/or
the removable analysis cartridge comprises one or more sample-absorbent pads, wherein at least one of the sample-absorbent pads is treated with a chemical reagent.

16. The system of claim 1, wherein the removable analysis cartridge comprises an optical collection well for presentation of the biological sample for optical analysis.

17. The system of claim 1, wherein the system further comprises an analyzer for measuring features of the biological sample, the analyzer comprising an imaging module, a chemistry analysis module, or a combination thereof.

18. The system of claim 17, wherein the analyzer further comprises a processor configured with instructions stored on a non-transitory computer readable medium to, when executed, cause the processor to perform acts comprising:
obtaining one or more measurements of the biological sample; and
interpolating a result from the one or more measurements.

19. A sample collection vessel comprising:
one or more holes that allow a biological sample to flow from a sample holding potion of the sample collection vessel onto and/or into a removable analysis cartridge,
a slot underneath the holes to house the removable analysis cartridge,
a flow locking mechanism to allow and prevent flow of the biological sample to the removable analysis cartridge,
an analysis cartridge locking mechanism that locks the removable analysis cartridge in place after insertion into the sample collection vessel and that releases the removable analysis cartridge for removal from the sample collection vessel.

20. A analysis cartridge comprising:
a flat strip comprising
one or more micro-wells comprising a chemical reagent and/or preservative, one or more sample-absorbent pads treated with a chemical reagent, or a combination thereof; and
an optical collection well for presentation of a biological sample for optical analysis.
